(19) United States
(12) Patent Application Publication
(10) Pub. No.: US 2024/0169475 A1
(43) Pub. Date: May 23, 2024

(54) GENERATING A REAL-TIME VIDEO STREAM OF A USER FACE BASED ON OBLIQUE REAL-TIME 3D SENSING

(71) Applicant: Endless Technologies Ltd., Ramat Gan (IL)

(72) Inventors: Roi GINAT, Los Gatos, CA (US); Nimrod SANDLERMAN, Ramat Gan (IL)

(73) Assignee: Endless Technologies Ltd., Ramat Gan (IL)

(21) Appl. No.: 18/574,628

(22) PCT Filed: Jun. 15, 2022
(86) PCT No.: PCT/US2022/033514

§ 371 Date: Dec. 27, 2023

Related U.S. Application Data
(60) Provisional application No. 63/215,469, filed on Jun. 27, 2021.

(51) Int. Cl. G06T 3/067; G06T 3/40; G06T 17/00

(52) U.S. Cl. CPC G06T 3/067; G06T 3/40; G06T 17/00

(57) ABSTRACT

A streaming 2D image of an object is by obtaining a 2D image of the object and a 3D measurement of the object from a first angle with respect to the object; creating a 3D model of the object using the 2D image and the 3D measurement; obtaining a streaming 3D measurement of the object from a second angle with respect to the object; and creating a streaming 2D image of the object, based on the 3D model of the object and the streaming 3D measurement, the streaming 2D image being created for a third angle with respect to the object, the first and the third angles being different from the second angle with respect to the object.

### FIELD

The method and apparatus disclosed herein are related to the fields of imaging, and more particularly but not exclusively, to wearable imaging devices, and more particularly but not exclusively, to real-time selfie imaging.

### BACKGROUND

Camera miniaturization, followed by price decrease, and augmented by proliferating and inexpensive communication services, introduced imaging to daily life. Instant image capturing and communication is easily available anywhere, anytime, and selfie imaging is particularly popular. However, selfie imaging requires a camera position in front of the user and therefore obstructing the user's line-of-sight. A selfie camera positioned outside the user's line-of-sight, at a slanted angle to the user's face, produces a distorted image, often lacking important features of the user's face. There is therefore a need for a system and a method for generating a real-time video stream of a user's face overcoming the abovementioned deficiencies.

### SUMMARY OF THE INVENTION

According to one exemplary embodiment, there is provided a device, a method, and a software program for an imaging system including a 3D image sensor mounted in a first angle with respect to an object to be imaged, where the object appearance is changing in time, and where the 3D image sensor is operative to create a 3D image of the object, the 3D image being captured from the first angle in real-time; a transceiver for communicating with an external communication device; and a controller communicatively coupled to the 3D image sensor and to the transceiver.

According to one exemplary embodiment, the controller may be configured to receive, via the transceiver, from an external camera a 2D image of the object, the 2D image taken by the external camera from a second angle with respect to the object, the second angle being different from the first angle. The controller may be additionally configured to create a 3D model of the object, based on a combination of the 3D image and the 2D image. The controller may be additionally configured to scan the object by the 3D image sensor in real-time. The controller may be additionally configured to create, in real-time, a 2D real-time image of the object, based on the 3D model and the 3D image being captured from the first angle in real-time. The controller may be additionally configured to communicate the 2D real-time image using the transceiver.

According to another exemplary embodiment, the 2D real-time image may be computed for the second angle.

According to yet another exemplary embodiment, the 2D image may be captured in relatively high resolution, and the 3D image may be captured in relatively low-resolution, and the 2D real-time image may be computed with the resolution of the 2D image; and

According to still another exemplary embodiment, the 2D image may be captured full color, and the 3D image may be captured with no colors, and the 2D real-time image may be computed with the colors obtained by the 2D image.

Further according to another exemplary embodiment, the controller may be additionally configured to use the transceiver to communicate with a mobile communication device including a camera and a display to receive from the mobile communication device a the 2D image of the object taken by the camera of the mobile communication device.

Additionally, according to another exemplary embodiment, the controller may be additionally configured to use the transceiver to communicate with the mobile communication device to display on the display of the mobile communication device the 2D real-time image of the object.

Still according to another exemplary embodiment, a cap may be provided having a visor and the imaging system being mounted on the visor facing the face of a user wearing the cap; and where the object being imaged is the face of the user wearing the cap.

According to yet another exemplary embodiment, the imaging system may capture a 3D, low-resolution, no-color, real-time image of the user's face in an angle to the profile of the user, and communicates a 2D high-resolution, full-color, real-time image of the profile of the user.

Further, according to another exemplary embodiment, the 2D real-time image may be provided as a video stream.

Additionally, according to another exemplary embodiment, a streaming 2D image of an object may be created with the following steps: Obtaining a 2D image of the object, the 2D image of the object obtained from a first angle with respect to the object. Obtaining a 3D measurement of the object, the 3D measurement of the object obtained from the first angle with respect to the object. Creating a 3D model of the object, the 3D model of the object being based on the 2D image of the object and the 3D measurement of the object. Obtaining a streaming 3D measurement of the object, the streaming 3D measurement of the object obtained from a second angle with respect to the object, the second angle being different from the first angle with respect to the object. And creating a streaming 2D image of the object, the streaming 2D image of the object being based on the 3D model of the object and the streaming 3D measurement of the object, the streaming 2D image of the object being created for a third angle with respect to the object, the third angle being different from the second angle with respect to the object.

According to yet another exemplary embodiment, additional steps may include any one or more of: Creating the streaming 2D image with a quality that is higher than the quality of the streaming 3D measurement of the object. Using a high-quality 2D image to create a high-quality 3D model to create a high-quality streaming 2D image, where the quality of the 2D image and the quality of the streaming 2D image is higher than the quality of the 3D measurement and the streaming 3D measurement of the object. Obtaining the streaming 3D measurement in real time. Creating the streaming 2D image in real time. Communicating the streaming 2D image of the object to at least one of a remote network server and a remote recipient client device. And providing the streaming 2D image as a video stream.

According to still another exemplary embodiment, the higher quality is at least one of higher spatial resolution, higher temporal resolution, and being colorful.

Further according to another exemplary embodiment, additional steps may include any one or more of: Using at least one of a smartphone camera, a handheld camera, and a wrist-mounted camera, to obtain the 2D image of the object. And using a cap mounted camera to obtain the streaming 3D measurement of the object where the object being imaged is the face of the user wearing the cap.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of a side view of an imaging device;

FIG. 2 is a simplified illustration of a side view of a head-mounted wearable imaging device;

FIG. 3 is a simplified block diagram of a process for the imaging device to generate a virtual streaming image of a real object;

FIG. 4 is a simplified block diagram of the imaging device;

FIG. 5 is a flow chart of a process executed by the imaging device using a 3D sensor;

FIG. 6 is a flow chart of another process executed by the imaging device using a 3D sensor;

FIG. 7A is a simplified illustration of a side view of a wearable imaging device;

FIG. 7B is a simplified illustration of a top view of the wearable imaging device;

FIG. 8 is a simplified block diagram of a computational device with imaging devices;

FIG. 9 is a simplified illustration of a wearable imaging device including a wearable article and two computational devices;

FIG. 10A is a simplified illustration of the imaging device shown from the inner (arm) side, and showing the 3D sensor and the selfie imaging unit;

FIG. 10B is a simplified illustration of the imaging device shown from the outer side, and showing the landscape imaging unit;

FIG. 11 is a simplified block diagram of a wearable complex including a block diagram of a computational device and a block diagram of an imaging device; and

FIG. 12 is a flow diagram of several alternative processes, where each process implements the steps of FIG. 4.

### DESCRIPTION OF THE EMBODIMENTS

The present embodiments comprise a method, one or more devices, and one or more software programs for generating a real-time streaming image of an object, based on 3D depth measurement taken from an oblique angle. The method, and/or devices, and/or software programs of the present embodiments are oriented at user portable imaging devices, including wearable imaging devices, including head-mounted, and/or hand-held, and/or wrist mounted imaging devices.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different figures may use different scales and different scales can be used even within the same drawing, for example different scales for different views of the same object or different scales for the two adjacent objects.

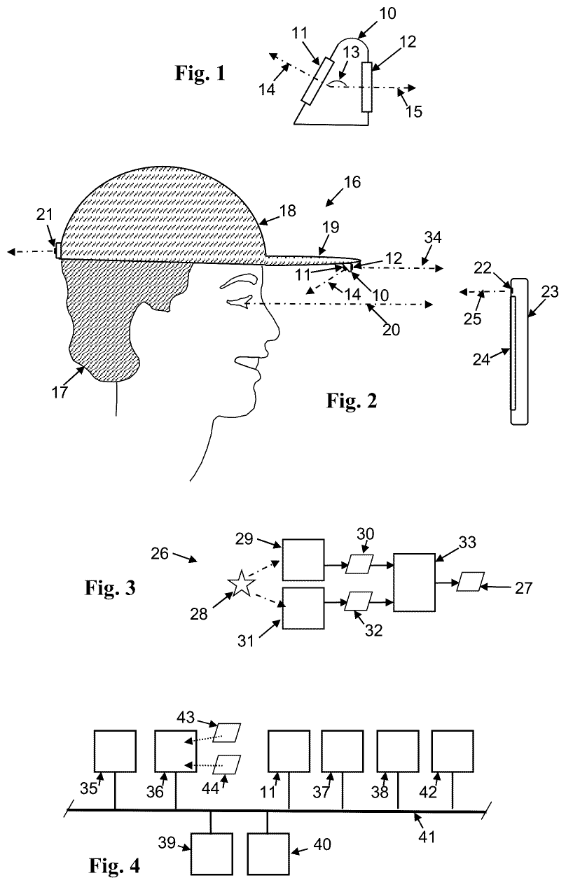

Reference is now made to FIG. 1, which is a simplified illustration of a side view of an imaging device 10, according to one exemplary embodiment. Imaging device 10 may include a 3D sensor 11, and optionally also an imaging unit 12.

The term ‘imaging device’ may refer to any type of camera, and/or any other optical sensor for creating an image of an object or a scene, including a streaming image such as a video stream. In some cases the term ‘imaging device’ may also refer to any type of 3D imaging device as further detailed below.

The term ‘streaming’ may refer to imaging content that is obtained, and/or communicated, and/or received, in a relatively high rate, such as high frame rate, such as video image. The term ‘video streaming image’, or simply ‘video’, may refer to a frame rate that is higher than the temporal resolution of the human eye and is therefore perceived as continuous motion picture. The term ‘slow streaming’ may refer to frame rate that is slightly below the temporal resolution of the human eye.

The term ‘computational device’ may refer to any type of computer, or a controller, or a processing device as will be detailed below.

The term ‘wearable article’ may refer to any type of article that can be worn by a user, or attached to a user, or carried by a user, or connect a device to a user. Such device may be a computational device and/or an imaging device and/or a device including a computational device and an imaging device such as imaging device 10.

As shown in FIG. 1, the 3D sensor 11 and imaging unit 12 are mounted in substantially opposite directions, typically with an angle 13 between the measuring axis 14 of the 3D sensor 11 and the optical axis 15 of the imaging unit 11. Angle 13 may be typically between 90 degrees and 180 degrees.

Hereinafter, 3D sensor 11 may be referred to as a depth sensor, or a selfie 3D sensor, or any combination of the terms ‘3D’, ‘depth’, ‘selfie’ and ‘sensor’. Hereinafter, imaging unit 12 may be referred to as a forward-looking imaging unit, or camera, or a landscape imaging unit, or camera, or any combination of the terms ‘forward-looking’, ‘landscape’, ‘imaging unit’, ‘imaging device’, and ‘camera’. 3D sensor 11 may be any type of sensor that creates a three-dimensional (3D) measurements of an object or a scene. Such 3D sensor 11 may use for example ‘time-of-flight’ measurements of an electromagnetic wave, or pulse, and/or an optical wave, or pulse, and/or an infrared (IR) wave, or pulse, and/or an acoustic wave, or pulse, etc. Therefore, 3D sensor 11 may produce a 3D real-time streaming image of an object or a scene even in poor light condition or even total darkness. However, typically, 3D sensor 11 may produce a relatively low-resolution image compared with a modern camera, and of no colors.

REAL3™ 3D image sensor available from Infineon Technologies AG, am Campeon 1-15, 85579 Neubiberg, Bavaria, Germany is an example of such 3D sensor 11. The REAL3™ 3D image sensor uses wavelength of 850 nm or 940 nm to produce a depth image of 224 by 172 pixels (38,528 pixels).

Imaging device 10 may also include a computerized device (not shown in FIG. 1) including a processor or a controller (not shown in FIG. 1) that may be controllably coupled to the 3D sensor 11 and/or the imaging unit 12. The processor or controller may be controllably coupled to a memory or storage device (not shown in FIG. 1) for storing data and software programs. The processor or a controller that may be controllably coupled a communication unit (not shown in FIG. 1) such as a transceiver to communicate with other devices. Imaging device 10 may also include a power supply and a power source (not shown in FIG. 1) such as a battery to power the Imaging device 10.

It is appreciated that imaging unit 12 may include any number of imaging units 12, which may be typically positioned in an arc to capture together a wide angle (e.g., panoramic) view.

Reference is now made to FIG. 2, which is a simplified illustration of a side view of a head-mounted wearable imaging device 16, according to one exemplary embodiment.

As an option, the head-mounted imaging device 16 of FIG. 2 may be viewed in the context of the previous Figures. Of course, however, FIG. 2 may be viewed in the context of any desired environment. Further, the aforementioned definitions may equally apply to the description below.

As shown in FIG. 2, head-mounted imaging device 16 is warn on a head of a user 17. In the example of FIG. 2, head-mounted imaging device 16 includes a cap 18 and an imaging device 10 mounted on the cap 18. As an example, imaging device 10 may be mounted on the bottom side of a visor 19 of the cap 18, in front of user 17 and not obstructing the line-of-sight 20 of user 17.

It is appreciated that both and any of head-mounted imaging device 16, and/or imaging device 10 when mounted on a user's head, may be considered a wearable device, and/or a wearable imaging device.

As shown in FIG. 2, 3D sensor 11 of imaging device 16 is directed toward the face of user 17, thus operating as a selfie sensor. Imaging unit 12 of imaging device 16 is directed away from the face of user 17, thus operating as a landscape camera.

Optionally, head-mounted imaging device 16 may also include a backward-looking imaging unit 21, such as a camera. Imaging unit 21 may capture the background scenery of user 17. It is appreciated that imaging unit 21 may include any number of imaging units 12, which may be typically positioned in an arc to capture together a wide angle (e.g., panoramic) view.

FIG. 2 also shows a camera 22, that may be as a hand-held camera, for example a camera of a smartphone 23 or any similar computational device (e.g., a tablet with a camera, a laptop with a camera, etc.). Particularly, a selfie camera of smartphone 23. The camera, or the smartphone may also include a display 24 and a communication unit such as a transceiver (not shown in FIG. 2). The transceiver may be used to communicate imaging data between camera 22 and imaging device 10.

It is appreciated that any camera 22 may produce an image (still or streaming) that may be considered high-quality two-dimensional (2D) imaging, as may be compared with the low quality three-dimensional (3D) imaging of the 3D sensor 11. Particularly, camera 12 and/or camera 21 may capture and provide colorful and/or high-resolution images, whether still images or streaming images. The colorful and/or high-resolution imaging of camera 12 and/or camera 21 may be considered of higher quality than the lower quality of the relatively lower resolution and colorless imaging of 3D sensor 11. The term ‘colorful’ may also refer to having a higher color resolution or a higher color depth.

The terms high-resolution and/or low-resolution nay refer to any of spatial resolution and/or temporal resolutions. Spatial resolution may refer, for example, to the number of pixels in a frame of the image. Temporal resolutions may refer, for example, to the number of frames per second.

As shown in FIG. 2, 3D sensor 11 is positioned to provide an oblique measurement, and/or scan, and/or sampling, and/or 3D imaging, of the user's face. In other words, measuring axis 14 of 3D sensor 11 is neither parallel, nor perpendicular, to the user's face. Therefore, 3D sensor 11 may capture, and/or provide, a 3D image of the user's face that may be distorted, and/or may be missing some details of the user's face.

Such distortion may result from a parallax view of the user's face. For example, upper and lower parts of the user's face are measured, and/or sampled, at an angle that is different than the angle of measuring and/or sampling lower parts of the user's face. Such missing details may be hidden by other parts of the user's face, such as protruding parts, such as the nose, eyebrows, chicks, chin, etc.

As shown in FIG. 2, camera 22 may be positioned to capture a frontal image of the user's face, as presented by optical axis 25 of camera 22 being substantially perpendicular to the user's face.

In other words, measuring axis 14 of 3D sensor 11 is in an angle to optical axis 25 of camera 22, so that 3D sensor 11 may capture a 3D image of the user's face in a first (oblique) angle, and camera 22 may capture an image of the user's face in a second (frontal) angle, where the first (oblique) angle is different from the second (frontal) angle.

It is appreciated that camera 22, and/or smartphone 23 (or any similar computational device) using its processor and communication unit, may communicate imaging data (e.g., high-quality 2D imaging) to imaging device 10 (e.g., via the processor and communication unit of imaging device 10). Similarly, 3D sensor 11 of imaging device 10 may use the processor and communication unit of imaging device to communicate imaging data (e.g., real-time low quality 3D imaging) to smartphone 23 (or any similar computational device, e.g., via the processor and communication unit of smartphone 23). Such communication may use any communication technology, including wireless WAN such as cellular communication (PLMN), wireless LAN such as Wi-Fi, wireless PAN such as Bluetooth (including Bluetooth Low Energy), and Near-Field Communication (NFC), etc.

Reference is now made to FIG. 3, which is a simplified block diagram of a process 26 for generating a virtual streaming image 27 of a real object 28, according to one exemplary embodiment.

As an option, the block diagram and/or process 26 of FIG. 3 may be viewed in the context of the previous Figures. Of course, however, FIG. 3 may be viewed in the context of any desired environment. Further, the aforementioned definitions may equally apply to the description below.

It is appreciated that while the description of FIG. 2 refers to imaging the face of a user, other embodiments are contemplated, for imaging one or more objects 28, which may be other human body parts and/or other objects, not necessarily human. It is appreciated that such embodiments may include the following three steps:
Step 1 (designated by numeral 29) may create a high-resolution and/or colorful 3D model 30 of object 28, where the 3D model is created with respect to a first optical axis, or a first angle with respect to object 28 (modeling angle).
Step 2 (designated by numeral 31) may obtain, in real-time, a 3D measurement 32 of object 28, from a second optical axis, or a second angle with respect to object 28 (sampling angle), which is different from the first optical axis or angle (modeling angle).
Step 3 (designated by numeral 33) may create a real-time 2D high-resolution and/or colorful 2D image 27 of object 28, with respect to a third optical axis, or angle with respect to object 28 (presentation angle). The presentation optical axis, or angle, is preferably different from the second (sampling) optical axis or angle, and may be different or the same as the first optical axis or angle (modeling angle).

The term ‘real-time’ may refer to capturing data or generating data in the present, ‘as it happens’. The term ‘streaming’ may refer to the data, captured or generated, as being continuous like, for example, a video stream. In this document, for simplicity, when the term ‘real-time’ is used it may also include ‘streaming’, and vice versa. Therefore, the term ‘real-time 3D measurement’ may refer to the term ‘streaming 3D measurement’ and vice-versa, including the term ‘real-time streaming 3D measurement’. Similarly, the term ‘real-time 2D image’ may refer to the term ‘streaming 2D image’ and vice-versa, including the term ‘real-time streaming 2D image’.

The real-time 2D may be created based on the 3D model obtained in step 1 and the real-time 3D measurement taken in step 3. The 3D measurement taken in step 3 is obtained from an optical axis, or angle (sampling angle), which is different from both the first optical axis, or angle (modeling angle), and the third optical axis, or angle (presentation angle). In this sense, the terms ‘optical axis’ and ‘angle’ may be used herein interchangeably.

The real-time 3D measurement of the body part or object obtained in step 2 may be streaming in the sense that it provides a repeated 3D measurements of the body part or object. The streaming may have a frame rate higher or lower than the typical temporal resolution of the human eye.

The real-time 2D measurement of the body part or object created in step 3 may be streaming in the sense that it provides a frame rate higher than the typical temporal resolution of the human eye. If the framerate of the 3D measurements is slow streaming (e.g., lower than the typical temporal resolution of the human eye) then the third step may create interpolated frames to provide high-rate streaming motion image.

In this respect, the real-time 2D image may present the body part or object from the third angle, while the real-time 3D measurement is taken from the second (oblique) angle, and while the 3D model is created from the first angle.

In this respect, the real-time image may present features of the body part or object that the real-time 3D measurement may not capture. For example, the real-time 3D measurement may not capture colors. For example, the real-time 3D measurement, being of low spatial and/or temporal resolution, may not capture features of relatively high spatial resolution or temporal resolution. For example, the real-time 3D measurement may not capture various details of the body part or object because the view of the body part or object second (oblique) angle may block and/or have no access to such hidden features of the body part or object.

The third angle, for which the real-time 2D streaming image may be created (in the third step), may be arbitrarily determined by a user, and/or selected by a user from a list of available third angles. The user may be the transmitting user (e.g., user 17) or a receiving user (not shown).

For example, the third angle (presentation angle) may be determined to be equal to the first angle (for which the 3D model is created). For example, the user may determine the first angle (modeling angle) according to the intended third angle (presentation angle). For example, the user may determine the third angle (presentation angle) according to an optical axis 34 of the landscape (front looking) camera 12 in FIG. 2.

Reference is now made to FIG. 4, which is a simplified block diagram of imaging device 10, being a computational device including at least 3D sensor 11, according to one exemplary embodiment.

As an option, the wearable imaging device 10 of FIG. 4 may be viewed in the context of the previous Figures. Of course, however, FIG. 4 may be viewed in the context of any desired environment. Further, the aforementioned definitions may equally apply to the description below.

As shown in FIG. 4, imaging device 10 may include a processor or controller 35, a memory and/or storage device 36, a communication device 37 such as a transceiver (or a receiver and transmitter devices), and 3D sensor 11. Imaging device may also include one or more imaging units 38 such as imaging unit 12 and/or imaging unit 21. Imaging device 10 may also include a power supply 39 and power source 40 such as a battery. All these devices and units may be coupled, electrically and/or controllably, via a bus 41 to controller 35.

Optionally, Imaging device 10 may also include other peripheral devices 42 such as user-interface devices, such as visual and/or auditory user-interface devices. An auditory user-interface may include a speaker or an earpiece.

A visual user-interface device may include a display, such as a head-up display, for example, a foldable screen, or a foldable see-through screen. Such head-up display may be enabled upon need to project to the user information, or content, or data, such as augmented reality. When not in use, such foldable screen may be folded up to the visor. Alternatively, a visual user-interface device may include a low-power laser projection module that projects to the eye.

It is appreciated that communication device 37 may communicate data any other communication unit of another computational device (such as smartphone 23) using any communication technology, including wireless WAN such as cellular communication (PLMN), wireless LAN such as Wi-Fi, wireless PAN such as Bluetooth, and Near-Field Communication (NFC), etc.

As shown in FIG. 4, memory and/or storage device 36 may include one or more software programs 43 and/or data 44. Such software program 43 may be executed and/or processed by processor 35 to control any of 3D sensor 11, imaging unit(s) 38, and communication device 37, as well as to process data 44. Data 44 may include imaging content captured by any of 3D sensor 11 and imaging unit(s) 38.

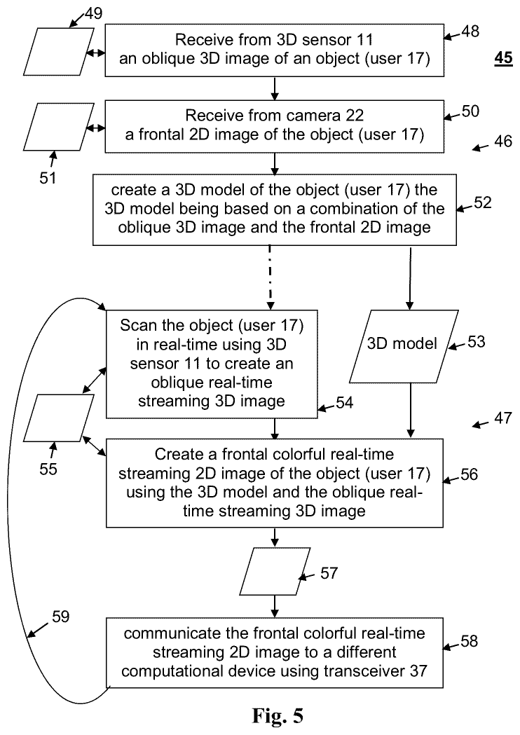

Reference is now made to FIG. 5, which is a flow chart of a process 45 executed by imaging device 10, being a computational device including at least a processor (controller 35), and 3D sensor 11, according to one exemplary embodiment.

As an option, the flow chart of FIG. 5 may be viewed in the context of the previous Figures. Of course, however, FIG. 5 may be viewed in the context of any desired environment. Further, the aforementioned definitions may equally apply to the description below.

Process 45 may include two parts, a preparatory part 46, and a real-time part 47. The preparatory part 46, or module, may create, or generate, a 3D model of an object such as the user's face. The real-time part 47, or module, may use a real-time scan of the object (e.g., user's face), and the 3D model, to create, or generate, a frontal colorful high-resolution 2D image of the object (e.g., user's face). The term ‘frontal image’ may refer to the third optical axis, or angle, of step 3 of FIG. 3. Preparatory part 46 may start with action 48 to receive from 3D sensor 11 an oblique 3D image 49 (e.g., scan, measurement, etc.) of a selected object such as the face of user 17. 3D image 49 has relatively low-resolution and has no colors (colorless).

Preparatory part 46 may then continue to action 50 to receive from camera 22 a frontal 2D image 51 of the object (user 17). 2D image 51 has relatively high-resolution (compared with the 3D image) and has colors (colorful).

Preparatory part 46 may then continue to action 52 to create, or generate, a 3D model 53 of the object (user 17). 3D model 53 may be based on a combination of the oblique 3D image 49 and the frontal 2D image 51. Therefore, 3D model 53 may be of high-resolution and colorful.

Real-time part 47 may start with action 54 to scan the object (user 17) in real-time using 3D sensor 11, and to create an oblique real-time streaming 3D image 55. Real-time streaming 3D image 55 has relatively low-resolution and is colorless.

Real-time part 47 may then continue to action 56 to create a real-time streaming 2D image 57 of the object (user 17). 2D image 57 is a colorful high-resolution frontal image of the object (user 17). Action 56 generates 2D image 57 using the 3D model 53 and the oblique real-time streaming 3D image 55.

Real-time part 47 may then continue to action 58 to communicate the frontal colorful real-time streaming 2D image 57 to any other computational device, for example over a communication network, for example using communication device (e.g., transceiver) 37. The other, different, computational device receiving the real-time streaming 2D image 57 may be, for example, a remote recipient, and/or a remote server, and/or a local server, such as a personal portable hub. A personal portable hub may be, for example, a smartphone carried by the user 17, or a smart watch warn by the user 17, etc.

It is appreciated that action 58 may communicate data to any other communication unit of another computational device (such as smartphone 23 and/or a remote client device, and/or a network server) using any communication technology, including wireless WAN such as cellular communication (PLMN), wireless LAN such as Wi-Fi, wireless PAN such as Bluetooth, and Near-Field Communication (NFC), etc.

In this respect, the terms ‘server’, or ‘hub’, may refer to any network node, or processing equipment. Such network node, or intermediating processing equipment, may support communication between the content originating device and the content receiving device (recipient). Such network node, or intermediating processing equipment, may also provide processing services as described herein.

It is appreciated that actions 54, 56, and 58 may be repeated, continuously, as indicated by arrow 59, to create a changing streaming high-resolution colorful frontal image of the object (user 17) as the object may change its appearance, and particularly facial appearance, for example, when user 17 may be moving or talking.

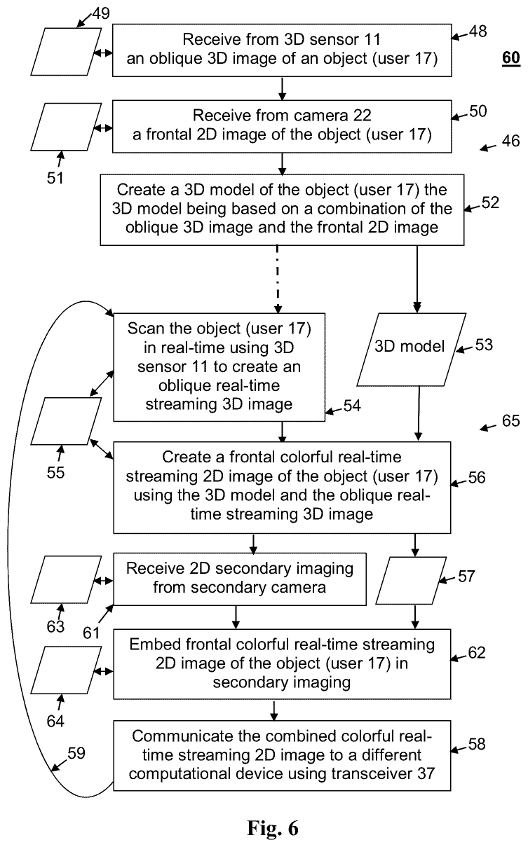

Reference is now made to FIG. 6, which is a flow chart of an alternative process 60 executed by imaging device 10, being a computational device including at least a processor (controller 35), and 3D sensor 11, according to one exemplary embodiment.

As an option, the flow chart of FIG. 6 may be viewed in the context of the previous Figures. Of course, however, FIG. 6 may be viewed in the context of any desired environment. Further, the aforementioned definitions may equally apply to the description below.

As shown in FIG. 6, alternative process 60 is similar to process 45 with the addition of actions 61 and 62. In action 61 process 60 may receive an image from a secondary camera. The secondary camera can be imaging unit 12 (e.g., forward-looking, landscape, camera, etc.), imaging unit 21 (e.g., backward-looking, background, camera, etc.), camera 22 (e.g., hand-held, wrist-mounted, smartphone, camera, etc.), or any other camera. The image received from the secondary camera is referred to as secondary image 63.

In action 62 process 60 may embed the frontal colorful real-time streaming 2D image 57 in the secondary image 63 to form a combined streaming image 64. In action 58 process 60 may communicate the combined streaming image 64 to any other computational device, local or remote, for example over a communication network, for example using transceiver 28.

It is appreciated that secondary image 63 may be a still picture, or a streaming image such as a video stream, or a still image obtained from a video stream. For example, action 62 may select, from time to time, a still frame for a video image produced by any of imaging unit 12 and imaging unit 21 to provide a stable background to a streaming frontal colorful real-time streaming 2D image of the user's face. The real-time part 65 of process 60 may be repeated, continuously, to provide a streaming combined image 64.

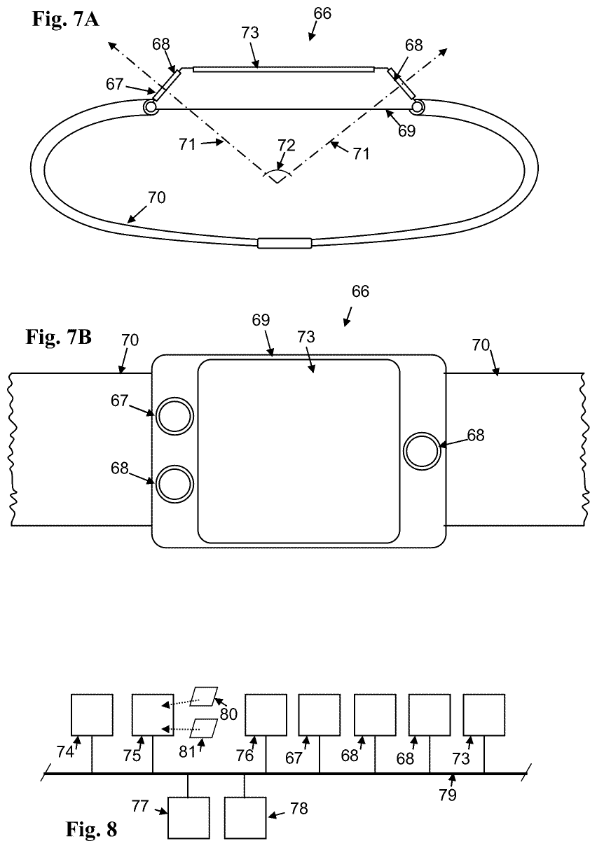

Reference is now made to FIG. 7A, which is a simplified illustration of a side view of a wearable imaging device 66, and to FIG. 7B, which is a simplified illustration of a top view of the wearable imaging device 66, according to one exemplary embodiment.

As an option, the illustrations of FIG. 7A and FIG. 7B may be viewed in the context of the previous Figures. Of course, however, FIG. 7A and FIG. 7B may be viewed in the context of any desired environment. Further, the aforementioned definitions may equally apply to the description below.

Wearable imaging device 66 may be used, for example, in the context of process 45 of FIG. 5 and/or process 60 of FIG. 6 as described herein. Wearable imaging device 66 may be used, for example, to provide the function of smartphone 23, and/or camera 22, for example with respect to preparatory part 46 of FIGS. 5 and/or FIG. 6.

Alternatively, or additionally, wearable imaging device 66 may be used, for example, to provide the function of imaging device 10 and/or 3D sensor 11, for example with respect to Real-time part 47 of FIG. 5 and/or Real-time part 65 FIG. 6.

Wearable imaging device 66 may include a 3D sensor 67, at least two imaging units 68, a computational device 69 controllably and/or communicatively coupled to imaging devices 69, and a wearable article 70 coupled to the computational device 69. Wearable article 70 enables a user to wear the computational device 69 with the imaging units 68 on the user's body. In the example shown in FIGS. 7A and 7B, the wearable article 70 is a wrist band for wearing the imaging device 66 on the user's wrist.

As shown in FIGS. 7A and 7B, 3D sensor 67 and a first imaging units 68 may be mounted in substantially opposing direction to a second imaging unit 68. For example, 3D sensor 67 and the first imaging units 68 imaging unit may be directed towards the user (e.g., as a selfie camera), and the second imaging unit 68 may be directed away from the user (e.g., a landscape camera).

The selfie units, e.g., 3D sensor 67 and the first imaging units 68, may have a parallel optical axes 71. The selfie units may be mounted in an angle 72 of less than 180 degrees between the of the lenses of the respective two imaging units 68, as shown in FIG. 7A.

Any of the selfie and landscape imaging units 68 may be a wide-angle imaging device. Alternatively or additionally, any of the selfie and landscape imaging units 68 may include a plurality of relatively narrow-angle imaging units 68 that together form a wide-angle view. Alternatively or additionally, any of the selfie and landscape imaging units 68 may include a combination of wide-angle and narrow-angle imaging units 68.

Computational device 69 may also include a display 73 and/or any other type of user-interface device.

It is appreciated that 3D sensor 67 of wearable imaging device 66 may be used in the same manner as 3D sensor 11 of imaging device 10 is used, as shown and described with reference to FIG. 5, and/or FIG. 6.

Reference is now made to FIG. 8, which is a simplified block diagram of computational device 69 with the imaging devices 68, according to one exemplary embodiment.

As an option, the wearable imaging device 82 of FIG. 8 may be viewed in the context of the previous Figures. Of course, however, FIG. 8 may be viewed in the context of any desired environment. Further, the aforementioned definitions may equally apply to the description below.

As shown in FIG. 8, computational device 69 may include a processor or controller 74, a memory and/or storage device 75, the 3D sensor 67, a communication device 76 such as a transceiver (or a receiver and transmitter devices), the two or more imaging units 68, a power supply 77 and power source 78 such as a battery, all connected via a bus 79. Computational device 69 may also include display 73 and/or any other type of user-interface device.

As shown in FIG. 8, memory and/or storage device 75 may include one or more software programs 80 and/or data 81, which may be executed and/or processed by processor 74 to control imaging units 68, and or communication device 76, and/or data 81. Data 81 may include imaging content captured by any of the imaging units 68. Such imaging content may include any type of imaging such as a still frame or a video stream. It is appreciated that process 45 of FIG. 5 and/or process 60 of FIG. 6 may apply to wearable imaging device 66, such as to be executed by processor 74.

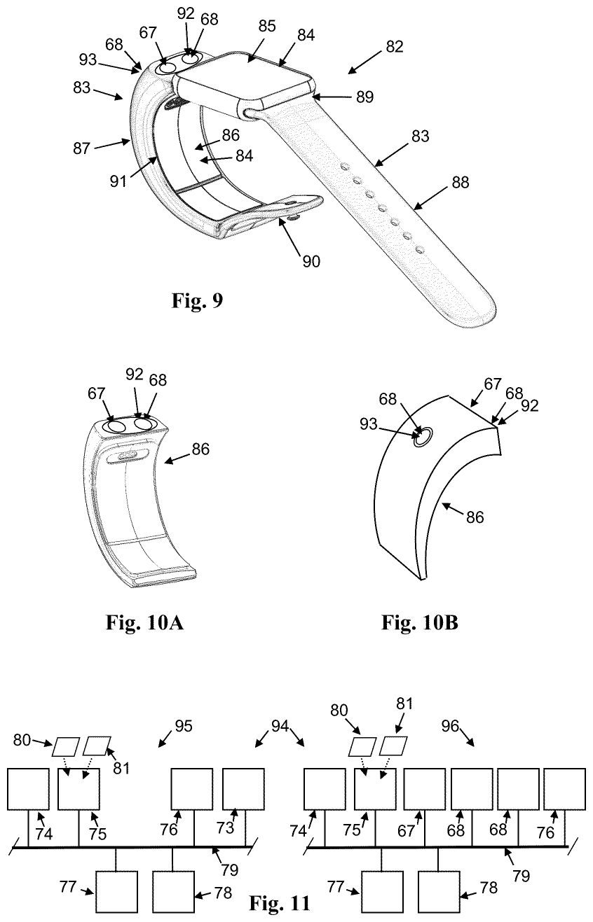

Reference is now made to FIG. 9, which is a simplified illustration of a wearable imaging device 82 including a wearable article 83 and two computational devices 84, according to one exemplary embodiment.

As an option, the wearable imaging device 82 of FIG. 9 may be viewed in the context of the previous Figures. Of course, however, the wearable imaging device 82 of FIG. 9 may be viewed in the context of any desired environment. Further, the aforementioned definitions may equally apply to the description below.

Wearable complex 82 may be used, for example, in the context of process 45 of FIG. 5 and/or process 60 of FIG. 6 as described herein. Wearable complex 82 may be used, for example, to provide the function of smartphone 23, and/or camera 22, for example with respect to preparatory part 46 of FIG. 5 and/or FIG. 6. Alternatively, or additionally, Wearable complex 82 may be used, for example, to provide the function of imaging device 10 and/or 3D sensor 11, for example with respect to Real-time part 47 of FIG. 5 and/or Real-time part 65 FIG. 6.

As shown in FIG. 9, wearable complex 82 may be designed to be warn on a user's limb, such as a user's extremity, such as a user's wrist. Thus, wearable complex 82 may include wearable article 83 in the form of a strip or a wristband arranged to attach the wearable complex 82 to a user's wrist, and one or more computational devices 84.

For example, wearable complex 82 may include a first computational device 84 such as a computerized watch, or a smartwatch, designated by numeral 85, and a second computational device 84 such as an imaging device designated by numeral 86.

It is appreciated that wearable complex 82 may function like wearable imaging device 66 with the difference that wearable complex 82 may have more than one processor and its associated components, and that the two computational devices of wearable complex 82 may communicate via respective communication units.

As shown in FIG. 9, wearable complex 82 may include wearable article 83 including one or more band parts such as a first band part 87 and a second band part 88. Both the first band part 87 and the second band part 88 may include a connector 89 to connect the respective band part to the computerized watch 85 on either side of the computerized watch 85. First band part 87 and the second band part 88 may also include a respective buckle part 90 to connect the first band part 87 to the second band part 88. The first band part 87, or second band part 88 (or both) may also include the imaging device 86.

As shown in FIG. 9, wearable complex 82, via wearable article 83, may include a cavity 91, for example, within first band part 87. Cavity 91 may be arranged with its opening towards the user's wrist. The imaging device 86 may be inserted into cavity 91, via the cavity opening, before the wearable complex 82 is warn on the user's wrist so that the imaging device 86 may be secured between the cavity 91 and the user's wrist.

Imaging device 86 may include 3D sensor 67 and a plurality of imaging units 68. Typically, 3D sensor 67 and at least one imaging unit 68 (designated by numeral 92) are mounted as a selfie camera towards the user, and at least one imaging unit 68 is mounted as a landscape camera directed away from the user. FIG. 9 shows the selfie imaging unit 68 while the landscape imaging unit 68 (designated by numeral 93 but not visible in FIG. 9) is mounted in the remote, hidden, side of wearable article 83.

Reference is now made to FIG. 10A, which is a simplified illustration of imaging device 86 shown from the inner side, and to FIG. 10B, which is a simplified illustration of imaging device 86 shown from the outer side, showing landscape imaging unit 68 designated by numeral 93, according to several exemplary embodiment.

As an option, the illustrations of FIG. 10A and FIG. 10B may be viewed in the context of the previous Figures. Of course, however, the illustrations of FIG. 10A and FIG. 10B may be viewed in the context of any desired environment. Further, the aforementioned definitions may equally apply to the description below.

Reference is now made to FIG. 11, which is a simplified block diagram 94 of wearable complex 82 including a block diagram 95 of computational device 85 (e.g. a smartwatch), a block diagram 96 of imaging device 86, according to one exemplary embodiment.

As an option, each of the block diagrams of FIG. 11 may be viewed in the context of the previous Figures. Of course, however, each of the block diagrams of FIG. 11 may be viewed in the context of any desired environment. Further, the aforementioned definitions may equally apply to the description below.

As shown in FIG. 11, block diagram 95, computational device 85 may include a processor 74, a memory and/or storage unit 75 including software program 80 and or data and/or content 81, a communication device 76, a display or any other user interface 73, a power supply 78 and a power source 79.

As shown in FIG. 11, block diagram 96, imaging device 86 may include a processor 74, a memory and/or storage unit 75 including software program 80 and or data and/or content 81, 3D sensor 67, a communication device 76, two or more imaging units 68, a power supply 78 and a power source 79.

It is appreciated that process 45 of FIG. 5 and/or process 60 of FIG. 6 may apply to wearable complex 82, such as to be executed by processor 74.

It is appreciated that the steps of FIG. 4, as well as the actions of FIGS. 5 and/or FIG. 6, may be executed by the same processor, such as the processor of imaging device 10, or the processor of wearable imaging device 66, or the processor of imaging device 86. However, the steps of FIG. 4, as well as the actions of FIG. 5 and/or FIG. 6, may be divided and executed by two or more processors.

For example, steps 1 and 3 of FIG. 4, or actions 46 and 56 of FIG. 5 or FIG. 6, may be executed by the processor of the computerized watch 85, while step 2 of FIG. 4, or action 54 of FIG. 5, or FIG. 6, may be executed by the processor of imaging device 86. Imaging device 86 may communicate real-time streaming 3D image 55 to computerized watch 85 to create real-time streaming 2D image 57 and to communicate it to a remote server or client recipient.

Alternatively, steps 1 and 2 of FIG. 4, or actions 46 and 54 of FIG. 5 or FIG. 6, may be executed by the processor of imaging device 86. Imaging device 86 may then communicate the 3d model to computerized watch 85, and thereafter communicate real-time streaming 3D image 55 to computerized watch 85. Then the processor of computerized watch 85 may execute step 3 of FIG. 4, or action 56 of FIG. 5 or FIG. 6 to create real-time streaming 2D image 57 and to communicate it to a remote server or client recipient.

It is appreciated that computerized watch 85 and imaging device 86 may communicate data, including imaging data, between them, as well as to any other communication unit of another computational device (such as a remote client device, and/or a network server). Computerized watch 85 and imaging device 86 may communicate data using, for example, their respective communication devices 76.

Communication between computerized watch 85 and imaging device 86 may use any communication technology, including wireless WAN such as cellular communication (PLMN), wireless LAN such as Wi-Fi, wireless PAN such as Bluetooth, and Near-Field Communication (NFC), etc. Wireless PAN may be used, for example, for communication between computerized watch 85 and imaging device 86. Wireless WAN may be used, for example, for communication between computerized watch 85 or imaging device 86 and a remote computational device such as a remote client device, and/or a network server.

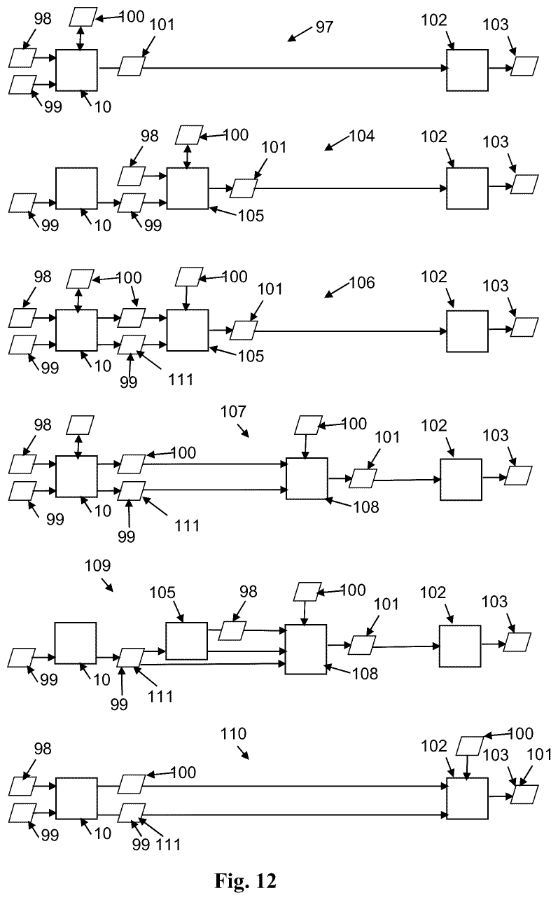

Reference is now made to FIG. 12, which is a flow diagram of several alternative processes, each process implementing steps 1, 2 and 3 of FIG. 4, however divided and/or arranged between a different plurality of processors, according to several exemplary embodiment.

As an option, the flow diagrams of FIG. 12 may be viewed in the context of the previous Figures. Of course, however, FIG. 12 may be viewed in the context of any desired environment. Further, the aforementioned definitions may equally apply to the description below.

In process 97, a processor of the imaging device 10 performs all the steps of FIG. 4, including obtaining a 2D high-quality image 98 of object 28 and obtaining a 3D image 99 of object 28, producing the 3D model 100, obtaining streaming 3D image of object 28 (99), creating streaming 2D image 101 of object 28, and communicating 2D image 101 to the recipient client device 102 to be displayed (103).

In process 104, a processor of a personal portable hub 105 such as a smartphone obtains the 2D high-quality image 98 of object 28, and receives the 3D image 99 of object 28 from the imaging device 10. The smartphone produces the 3D model 100, and then receives streaming 3D image 99 from the imaging device 10. The smartphone then creates streaming 2D image 101 of object 28, and communicates the 2D image 101 to the recipient client device 102 to be displayed (103).

In process 106, the imaging device 10 obtains the 2D high-quality image 98 of object 28 and the 3D image 99 of object 28, produces the 3D model 100 and communicates it to a personal portable hub 105 such as a smartphone. The smartphone 105 receives streaming 3D image 99 from the imaging device 10, creates streaming 2D image 101 of object 28, and communicates the streaming 2D image 101 to the recipient client device 102 to be displayed (103).

Process 107 is similar to process 106 however using a remote network server 108 instead of smartphone 105 (or personal portable hub 105). Remote network server 108 may then compute the 3D model 100 and then compute the streaming 2D image 101, and communicate it to the recipient client device 102 to be displayed (103).

Process 107 may reduce the processor load on smartphone 105, or personal portable hub 105, for example, by processing the streaming 2D image 101 using the processor of network server 108. Thus, process 107 may also reduce the power consumption on their respective batteries. Additionally, process 109 may communicate in real-time between imaging device 10 and network server 108 the 3D image 99, instead of the streaming 2D image 101, and therefore also reduce the load on this part of the network.

In process 109 a camera of smartphone 105 (or a camera connected to personal portable hub 105) may obtain the 2D high-quality image 98 (of object 28) and communicate it to network server 108. Imaging device 10 may obtain 3D image 99 (of object 28) and communicate it to network server 108, in parallel, wither directly, or via smartphone 105 (or personal portable hub 105). Remote network server 108117 may then compute the 3D model 100, and thereafter compute the streaming 2D image 101 and communicate it to the recipient client device 102 to be displayed (103).

By processing the 3D model 100, and the streaming 2D image 101, by the processor of network server 108, process 109 may reduce the processor load on smartphone 105, or personal portable hub 105, and/or imaging device 10, and thus also reduce the power consumption on their respective batteries. Additionally, process 109 may communicate in real-time between imaging device 10 and network server 108 only the 3D image 99 (instead of the streaming 2D image 101) and therefore also reduce the load on this part of the network.

In process 110, the imaging device 10 obtains the 2D high-quality image 98 and the 3D image 99 of object 28, produces the 3D model 100, and communicates the 3D model 100 to the recipient client device 102. The imaging device 10 then obtains the streaming 3D image of object 28 (99), and communicates it to the recipient client device 102. The recipient client device 102 then creates streaming 2D image 101 of object 28 to be displayed (103). Process 110 may also reduce the processing load and power consumption on imaging device 10 as well as reducing the bandwidth requirement on the communication network.

Alternatively, in any of processes 104, 106, 107, and 110, the processor of imaging device 10 (or the processor portable personal hub 105 in process 104) may analyze the streaming 3D image 99 according to 3D model 100 to derive streaming parameters 111 of the 3D image 99. The streaming parameters 111 are then communicated to the next processor (or stage, or device). The next processor (or stage, or device) may then produce the streaming 2D image 101 of object 28 based on the 3D model 100 and the streaming parameters 111.

Communicating streaming 3D parameters' data instead of the streaming 3D imaging content may be useful to reduce bandwidth requirement and optionally also to reduce processing power and/or electric (battery) power. For example, analyzing and communicating 3D parameters' data may require less processing power (and/or electric power) than compressing and communicating streaming 3D imaging content.

Processes 107, 109 and 110 may be particularly useful to enable any recipient user to determine the presentation angle (or optical axis). For example, in processes 107 the recipient user may determine the presentation angle using a user interface of the recipient client device 102, and communicate the selected presentation angle to the network server 108, so that the network server 108 may create the streaming 2D image 101 according to the presentation angle selected by the particular recipient user.

It is appreciated that imaging device 10, personal portable hub 105, network server 108, and recipient client device 102 may communicate data between them, including imaging data, typically using respective communication devices, or units, or module, such as transceivers.

Such communication of data and imaging content may use any communication technology, including WAN, including wireless WAN such as cellular communication (PLMN), LAN, including wireless LAN such as Wi-Fi, PAN, including wireless PAN such as Bluetooth (including Bluetooth Low Energy), etc. Any such technology can be used for a particular purpose and/or leg of the communication, for example considering real-time requirements and network limitations such as bandwidth jitter, latency, etc.

For example, wireless PAN may be used for communication between imaging device 10 and personal portable hub 105. Wireless WAN or wireless LAN may be used, for example, for communication between device 10 or personal portable hub 105 and network server 108, and/or recipient client device 102. WAN or wireless WAN may be used, for example, for communication between network server 108, and recipient client device 102.

It is appreciated that other configurations of the above processes are also contemplated.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation, or identification of any reference in this application shall not be construed as an admission that such reference is available as prior art.

What is claimed is:

1. An imaging system comprising:
an 3D image sensor mounted in a first angle with respect to an object to be imaged, wherein the object appearance is changing in time, and wherein the 3D image sensor is operative to create a 3D image of the object, the 3D image being captured from the first angle in real-time;
a transceiver for communicating with an external communication device; and
a controller communicatively coupled to the 3D image sensor and to the transceiver;
wherein the controller is configured to:
receive, via the transceiver, from an external camera a 2D image of the object, the 2D image taken by the external camera from a second angle with respect to the object, the second angle being different from the first angle;
create a 3D model of the object, based on a combination of the 3D image and the 2D image;
scan the object by the 3D image sensor in real-time;
create, in real-time, a 2D real-time image of the object, based on the 3D model and the 3D image being captured from the first angle in real-time; and
communicate the 2D real-time image using the transceiver.

2. The imaging system according to claim 1, wherein the 2D real-time image is computed for the second angle.

3. The imaging system according to claim 1, additionally comprising at least one of:
wherein the 2D image is captured in relatively high resolution, and wherein the 3D image is captured in relatively low-resolution, and wherein the 2D real-time image is computed with the resolution of the 2D image; and
wherein the 2D image is captured full color, and wherein the 3D image is captured with no colors, and wherein the 2D real-time image is computed with the colors obtained by the 2D image.

4. The imaging system according to claim 1, wherein the controller is additionally configured to:
use the transceiver to communicate with a mobile communication device comprising a camera and a display to receive from the mobile communication device a the 2D image of the object taken by the camera of the mobile communication device; and
use the transceiver to communicate with the mobile communication device to display on the display of the mobile communication device the 2D real-time image of the object.

5. The imaging system according to claim 1, additionally comprising:
a cap having a visor and wherein the imaging system is mounted on the visor facing a user's face wearing the cap; and
wherein the object being imaged is the face of the user wearing the cap.

6. The imaging system according to claim 5, wherein the imaging system captures a 3D, low-resolution, no-color, real-time image of the user's face in an angle to the profile of the user, and communicates a 2D high-resolution, full-color, real-time image of the profile of the user.

7. The imaging system according to claim 5, wherein the 2D real-time image is provided as a video stream.

8. A computer-implemented method for creating a streaming 2D image of an object, the method comprising:
obtaining a 2D image of the object, the 2D image of the object obtained from a first angle with respect to the object;
obtaining a 3D measurement of the object, the 3D measurement of the object obtained from the first angle with respect to the object;
creating a 3D model of the object, the 3D model of the object being based on the 2D image of the object and the 3D measurement of the object;
obtaining a streaming 3D measurement of the object, the streaming 3D measurement of the object obtained from a second angle with respect to the object, the second angle being different from the first angle with respect to the object; and
creating a streaming 2D image of the object, the streaming 2D image of the object being based on the 3D model of the object and the streaming 3D measurement of the object, the streaming 2D image of the object being created for a third angle with respect to the object, the third angle being different from the second angle with respect to the object.

9. The computer-implemented method according to claim 8 additionally comprising at least one of:
creating the streaming 2D image with a quality that is higher than the quality of the streaming 3D measurement of the object;
using a high-quality 2D image to create a high-quality 3D model to create a high-quality streaming 2D image, wherein the quality of the 2D image and the quality of the streaming 2D image is higher than the quality of the 3D measurement and the streaming 3D measurement of the object;
obtaining the streaming 3D measurement in real time;
creating the streaming 2D image in real time;
communicating the streaming 2D image of the object to at least one of a remote network server and a remote recipient client device; and
providing the streaming 2D image as a video stream.

10. The computer-implemented method according to claim 9, wherein the higher quality is at least one of higher spatial resolution, higher temporal resolution, and being colorful.

11. The computer-implemented method according to claim 8 additionally comprising at least one of:
using at least one of a smartphone camera, a handheld camera, and a wrist-mounted camera, to obtain the 2D image of the object; and
using a cap mounted camera to obtain the streaming 3D measurement of the object wherein the object being imaged is the face of the user wearing the cap.

12. A computer program product embodied on a non-transitory computer readable medium comprising computer code for:
obtaining a 2D image of the object, the 2D image of the object obtained from a first angle with respect to the object;
obtaining a 3D measurement of the object, the 3D measurement of the object obtained from the first angle with respect to the object;
creating a 3D model of the object, the 3D model of the object being based on the 2D image of the object and the 3D measurement of the object;
obtaining a streaming 3D measurement of the object, the streaming 3D measurement of the object obtained from a second angle with respect to the object, the second angle being different from the first angle with respect to the object; and
creating a streaming 2D image of the object, the streaming 2D image of the object being based on the 3D model of the object and the streaming 3D measurement of the object, the streaming 2D image of the object being created for a third angle with respect to the object, the third angle being different from the second angle with respect to the object.

13. The computer program product according to claim 12 additionally comprising computer code for at least one of:
creating the streaming 2D image with a quality that is higher than the quality of the streaming 3D measurement of the object;
using a high-quality 2D image to create a high-quality 3D model to create a high-quality streaming 2D image, wherein the quality of the 2D image and the quality of the streaming 2D image is higher than the quality of the 3D measurement and the streaming 3D measurement of the object;
obtaining the streaming 3D measurement in real time;
creating the streaming 2D image in real time;
communicating the streaming 2D image of the object to at least one of a remote network server and a remote recipient client device; and
providing the streaming 2D image as a video stream.

14. The method according to claim 13, wherein the higher quality is at least one of higher spatial resolution, higher temporal resolution, and being colorful.

15. The computer program product according to claim 12 additionally comprising computer code for at least one of:
using at least one of a smartphone camera, a handheld camera, and a wrist-mounted camera, to obtain the 2D image of the object; and
using a cap mounted camera to obtain the streaming 3D measurement of the object wherein the object being imaged is the face of the user wearing the cap.
